(19) United States
(12) Patent Application Publication
(10) Pub. No.: US 2002/0082970 A1
(43) Pub. Date: Jun. 27, 2002

(54) Integrated transportation

(76) Inventors: James Vincent Ciroli JR., Norwich, OH (US); David Richard Frio, St. Clairsville, OH (US)

Correspondence Address: Douglas G. Glantz, Attorney At Law, 5260 Deborah Court, Doylestown, PA, 18901-1949, US

(21) Appl. No.: 09/742,847

(22) Filed: Dec. 21, 2000

(51) Int. Cl. G06F 17/60

(52) U.S. Cl. 705/37

(57) ABSTRACT

Method and apparatus are disclosed for enabling a plurality of independent entities including a plurality of shippers and a plurality of carriers having connection to a communication network to conduct business transactions relating to shipment of goods.

### FIELD OF THE INVENTION

This invention relates to a computerized transaction apparatus and method of doing business, enabling independent entities including shippers and carriers to negotiate contracts for transportation or carriage of goods.

### BACKGROUND OF THE INVENTION

Major participants in the transportation industry include shippers and carriers as well as third parties including freight brokers and logistics companies involved in the shipment of goods from a source to a destination.

In the current market place, a shipper has a need to move goods from one point, the origin, to another point, the destination. The shipper may be a manufacturer, a warehouse owner, or any entity having a reason to ship cargo from an origin to a destination. The origin may be a manufacturing plant, a warehouse, or a port of entry. The destination may be another manufacturing plant, a warehouse, a port, or directly to a consignee. The motor freight industry alone carries approximately four million full load shipments per day. Additional shipments are carried by rail, air, and water borne vessels.

Within most organizations, shipments are managed by the organization's traffic or shipping departments, but they also may be managed by the purchasing department. The departments charged with shipping have numerous tasks to perform, usually on numerous disparate computer systems and manual systems. These shipment tasks include monitoring internal shipping requirements, and requirements may be routed manually or via an internal computer system; placing shipments with carriers, normally done via telephone or fax; obtaining requests for quote from carrier for future shipments, normally done by telephone or FAX; maintaining and renewing existing contracts with carriers; monitoring carrier performance, including safety performance, delivery performance, cargo damage etc.; create management reports by internal computer systems but often created manually using spreadsheet data, such management reports provide management with high-level data about the performance of the shipping department and the carriers they manage; updating the internal systems, including but not limited to, accounts payable, risk management, vendor maintenance, and the manufacturing systems.

### INTRODUCTION TO THE INVENTION

Of the preceding list of shipment tasks, it can be seen that the conventional process is inefficient and requires many manual steps. Because of the inefficiencies and the effort required to maintain relationships with the carriers, the shipping group normally limits the number of carriers with which it deals. Despite price advantages in dealing with a large number of carriers, due to the amount of manual work required, it becomes impossible or cost prohibitive for the department to do so.

In some cases, shippers will outsource some or all of their shipper requirements. If all the requirements are outsourced, the shipper will deal with a logistics company whose responsibility it will be to transport the shippers' cargo as required. The logistics company performs many of the tasks associated with a shipper but also may function as a carrier. Partial outsourcing normally is done by the use of brokers or freight forwarders.

The brokers and freight forwarders will obtain, for a fee, using the shippers' guidelines, the best trucking arrangement for the shippers. In this case, the broker has the majority of the responsibilities listed above.

The motor freight industry, particularly, is characterized by large numbers of participants. There are, for example, approximately 40,000 trucking entities in the United States, the majority having less than five trucks.

Aside from the major purpose for its existence, i.e., carrying cargo, the carrier's other major function revolves around the sales and accounting functions. The sales and accounting functions are of extreme importance to the carrier as they keep the carrier in business. The major carriers will have entire back office and sales operations devoted to the sales and accounting functions. Whereas the smaller carriers will have smaller operations, all carriers will have staff spending a significant amount of time on the sakes and accounting functions. The functions performed by the sales and back office staff include optimizing the use of the equipment. The carrier makes use of much equipment requiring a large capital outlay. Equipment that is idle lays this investment to waste. Likewise, however, equipment used for the incorrect purpose also lays this investment to waste, for example, using a refrigerated trailer for items not requiring refrigeration.

Functions performed by the sales and back office staff also include getting the drivers home. Most long haul carriers have an agreement with their drivers that will include the number of days a driver will spend on the road before returning home. It thus becomes essential for dispatch to be able to plan routes whereby the driver can return home. Functions performed by the sales and back office staff also include finding back hauls. In many cases, it is difficult to determine the profitability of taking a shipment as it is not known whether there will be a load for the return trip.

Functions performed by the sales and back office staff also include managing contracts. To deal with uncertainty, many carriers may have contracts with shippers. These contracts must be managed and communications from the shipper regarding shipments must be fed into the equipment optimization equation. The functions perfomed by the sales and back office staff further include obtaining new business. The functions perfomed by the sales and back office staff further include management reporting and maintaining internal systems. These internal systems will include the accounting and billing systems, the payroll systems and the internal systems that manage the movement of equipment. As can be seen from the preceding list, the back office function includes many roles, resulting in a considerable workload on the typical back office staff. Most of the workload is achieved using manual systems and the telephone and fax, or at best the workload is achieved by the use of disparate computer systems. The majority of carriers are small corporations, hence the quantity of staff available to perform these functions is limited, and thus the work suffers.

An additional aspect of the background of the invention is the availability of networked computer systems. At the present time, the Internet is the most extensive of the networked computer systems.

The Internet is a global communication network which may economically be accessed economically by even the smallest of business entities. Alphameric information, graphic information, and other types of information can be communicated easily between remote parties.

Some web sites on the Internet have been created for assisting communications connected with transportation. Bulletin boards can provide shippers with a formum to post loads, to be viewed by carriers.

Various technologies have been developed for security on the Internet including password protection, file encryption, and firewalls. Markup languages such as Hypertext Markup Language (HTML) and Extensible Markup Language (XML) are available, which include tags inserted in a data stream, the tags enabling blocks of data representing fields in a file to be labeled as to the types of information represented by the fields. Markup languages make it possible to have blocks of data having arbitrary length.

Search engines have been developed which enable users to search the Internet for key words and phrases. Search engines enable many files having labeled fields to be searched for key words, phrases, and other information in specific fields. For example, Internet sites containing information on issued patents can enable one to search for specified alphameric material in specific fields. In particular, one may search for all inventions by a given inventor having certain key words in the title, abstract, or claims. Some employment-related search engines provide a user with the ability to search for city, state, or ZIP code of a prospective employer; and some enable a user to search for employment opportunities within a predetermined distance from a city, state, or ZIP code. E-mail systems provide for automatic transmission of messages.

Host computers connected to high capacity communication lines of the Internet are available to website developers and provide the developers with reliable, high information rate connection to the Internet, as well as reliable storage of data. Computer networks, including the Internet, facilitate information processing relating to various business transactions.

U.S. Pat. No. 5,937,393 “Order Processing Method in a Distributed Processing System with Local Validation and Dynamic Control of the Order Request Through a Configuration Matrix” applies to a distributed computer system which may be a corporate intranet, or the Internet. U.S. Pat. No. 5,937,393 provides for reducing paperwork involved in the processing and validation of orders.

U.S. Pat. No. 5,910,896 “Shipment Transaction System and an Arrangement Thereof” applies to an environment of multiple shippers and carriers. It concerns itself with processing information related to shipment transactions in which goods shipped from one of the shippers by one of the carriers.

U.S. Pat. No. 5,758,328 “Computerized Quotation System and Method” describes an Internet home page in which a buyer of goods or services can connect, select a product type, and request a quotation from vendors. The system then sends the request for quotation by E-mail to vendors who supply the selected product type. The vendors reply to the system by E-mail, and the system sends the quotations to the buyer.

U.S. Pat. No. 5,485,369 “Logistics system for Automating Transportation of Goods” facilitates the process of shipping goods by a shipper having a predefined set of shipping requirements via a carrier having a predefined rate structure U.S. Pat. No. 5,222,018 System for Centralized Processing of Accounting and Payment Functions provides a central data processing facility which maintains accounts for shippers and carriers. The system credits and debits costs for each shipment.

U.S. Pat. No. 5,168,444 “Shipment System Including Processing of Document Images” provides an integrated shipping transaction management system having remote stations. The system provides for processing images of shipping transaction documents.

U.S. Pat. No. 4,799,156 “Interactive Market Management System” permits business chat sessions between sellers, buyers, financial institutions, and freight service providers. The system enables a buyer of goods to submit a request for quote. Then, based on data in the system, the system may prepare a bid.

U.S. Pat. No. 4,567,359 “Automatic Information, Goods and Services Dispensing System” describes a central processing system in which service and price rate information are stored. The system includes sales terminals providing information to customers and which also enable customers to transmit orders to the central processing system. The central processing system includes means for accepting and processing customer orders for goods, information, and services. Apparatus and method are needed to enable and facilitate an integrated transportation for shipment of goods by shippers and carriers.

### OBJECTIVES OF THE INVENTION

It is, therefore, an objective of the present invention to facilitate the communications needed for the transportation industry.

It is an objective of the present invention to facilitate communications between shippers and carriers.

Another objective of the present invention is to reduce telephone and FAX expenses in the transportation industry.

Yet another objective of the present invention is to provide a neutral on-line marketplace for shippers and carriers.

An additional objective of the present invention is to enable shippers to transmit requests for carriage of loads to a large universe of carriers.

A related objective of the present invention is to enable shippers to post multiple loads very quickly.

An objective of the present invention is to enable shippers to obtain the best bid possible for every load.

It is another objective of the present invention to enable shippers to move freight in undesirable lanes.

A further objective of the present invention is to provide increased visibility to unknown shippers.

Still another objective of the present invention is to enable shippers to post loads openly, so all carriers may place bids.

Yet an additional objective of the present invention is to enable shippers to post loads which are visible only to a preferred carrier or preferred group of carriers.

It is an additional objective of the present invention to enable third parties including freight brokers and logistics companies to arrange for carriage of loads posted by shippers.

It is another objective of the present invention of the present invention to enable third parties including freight brokers and logistics companies to find loads for available carriage equipment.

A further objective of the present invention is to enable carriers to bid on loads posted by a large universe of shippers.

An additional objective of the present invention is to provide increased visibility to unknown carriers.

Another objective of the present invention is to enable carriers to access the most profitable lanes.

It is also an objective of the present invention to enable carriers to search for loads according to city, state and ZIP code of origin and destination of loads.

It is still another objective of the present invention to provide carriers with accurate load details.

It is a further objective of the present invention to enable carriers to search for loads according to predetermined criteria including origin and destination of loads, the type of material or goods to be carried and the type of carriage equipment required.

It is also an objective of the present invention to optimize the use of carriage equipment.

Yet another objective of the present invention is to find back hauls so drivers may return home.

Another objective of the present invention is to provide a bidding system in which a carrier may find a back haul before placing a bid to carry a load.

An additional objective of the present invention is to provide a bidding system in which shippers may elect to make bids public, so carriers may view each other's bids.

A further objective of the present invention is to provide a bidding system in which shippers may elect to make bids private, so each carrier bids without reference to bids by other carriers.

Another objective of the present invention is to post loads and automatically send electronic messages encouraging a selected group of shippers to look at the loads.

It is also an objective of the present invention to enable carriers to place time limits on bids to encourage quick acceptance of a low bid.

Yet another objective of the present invention is to provide a transportation marketplace which may be expanded by state of the art means to accommodate additional participants.

Another objective is to provide an electronic marketplace which may be accessed by even very small shippers and carriers.

An additional objective is to enable shippers and carriers to negotiate contracts.

A further objective is to provide shippers with management reports.

It is also an objective to provide carriers with management reports.

These and other objectives of the present invention will become apparent after a careful review of the detailed description and the figures of the drawings which follow.

### SUMMARY OF THE INVENTION

The invention provides apparatus and method for enabling a plurality of independent entities including a plurality of shippers and a plurality of carriers to conduct business transactions relating to shipment of goods. Each of the entities has connection to a communication network, such as the Internet.

The invention includes load posting means and method for enabling a shipper to post information indicative of loads on the communication network, and load viewing means and method for enabling a carrier to view posted loads. It also has bid placing means and method for enabling the carrier to place bids on the communication network for carrier selected ones of the loads.

Preferably, a plurality of shippers and a plurality of carriers may post loads and bids, and the invention, preferably, includes evaluation means enabling the shippers to evaluate the bids and place information indicative of awarded contracts for shipper selected bids.

In one aspect, the invention is a method of enabling a plurality of independent entities including a plurality of shippers and a plurality of carriers to conduct business transactions relating to shipment of goods. Each of the entities has connection to a communication network, preferably the Internet. The method includes enabling shippers to post information indicative of loads on the communication network, and enabling the carriers to view the posted loads. It also includes enabling the carriers to place bids for carrier selected loads. Preferably, it also includes enabling the shippers to evaluate the bids and place information indicative of awarded contracts for shipper selected bids on the communication network, and includes enabling the carriers to place information indicative of acceptance of carrier preselected ones of the awarded contracts on the communication network.

In one aspect, the invention is an apparatus for enabling a plurality of independent entities including a plurality of shippers and a plurality of carriers to conduct business transactions relating to shipment of goods, each of the plurality of entities having connection to a communication network. The apparatus includes load posting means enabling the shippers to post information indicative of loads on the communication network, the information indicative of loads including type of load, type of carriage means required, required delivery time and date, city, state, and ZIP code of point of origin of load, city, state, and ZIP code of destination of load and shipper requirements for the loads.

The invention includes load viewing means and method enabling the carriers to view the information indicative of the loads, the load viewing means including search means enabling the carriers to search for type of load, type of carriage means required, required delivery time and date, city, state, and ZIP code of point of origin of load, city state, and ZIP code of destination of loads and back hauls corresponding to the loads.

The invention further includes bid placing means and method enabling the carriers to place bids for carrier selected ones of the loads on the communication network, the bid placing means including means for placing time limits on the bids. The apparatus also has evaluation means enabling the shippers to evaluate the bids and place information indicative of awarded contracts for shipper selected ones of the bids on the communication network; and confirmation means enabling the carriers to place information indicative of acceptance of carrier selected ones of the awarded contracts on the communication network.

### BRIEF DESCRIPTION OF THE DRAWINGS

FIG. 1 is a schematic illustration of the present invention for integrated transportation.

FIG. 2 is a schematic illustration of the hardware infrastructure in which the present invention is practiced.

FIG. 3 illustrates the integrated transportation process by which a shipper posts a load according to the invention.

FIG. 4 illustrates the integrated transportation process by which a carrier views the posted loads, selects a load on which to bid, and places a bid.

FIG. 5 illustrates the activities of a shipper and carrier in regard to finalizing a contract for integrated transportation.

### DETAILED DESCRIPTION

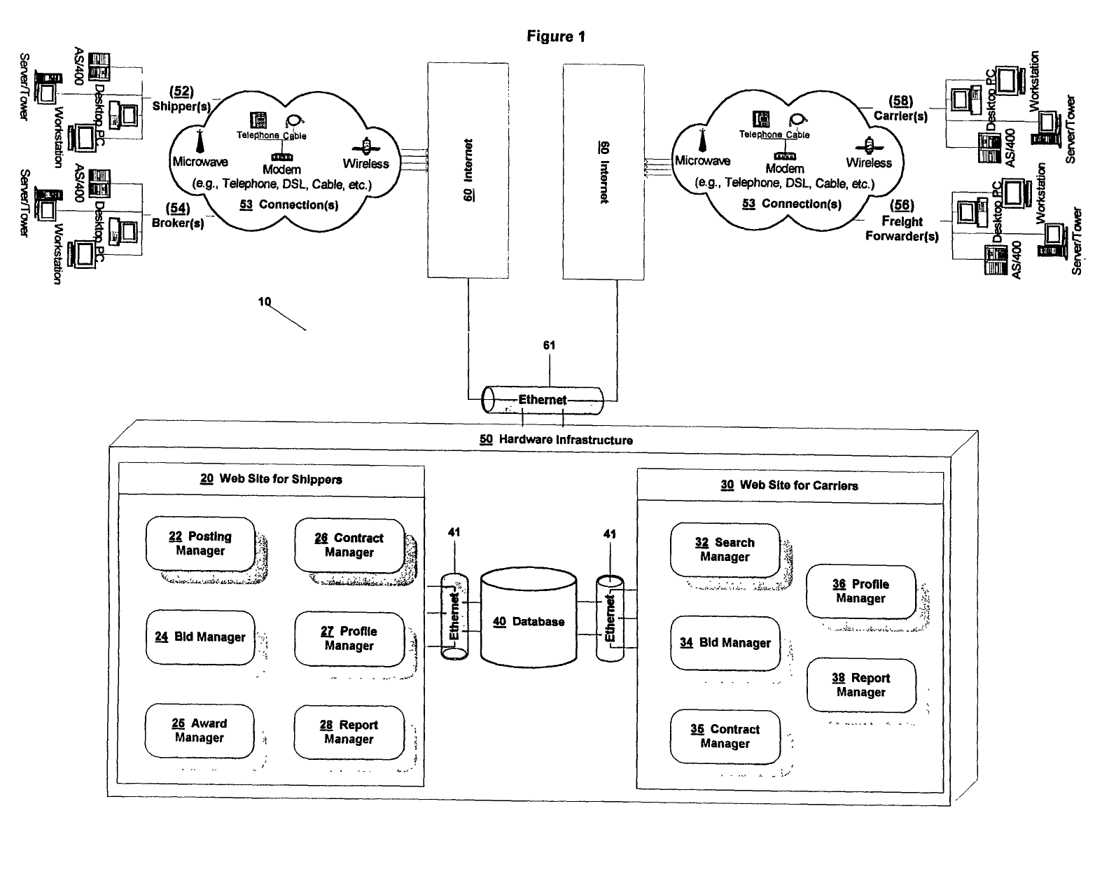

Attention is now directed to FIG. 1, which illustrates the presently preferred embodiment of the invention. The invention 10 is a means and method for enabling a plurality of independent entities including shippers, carriers, and other business entities to conduct business transactions relating to a shipment of goods, each of the entities having connection to a communication network. It is presently preferred that the communication network 60 be the Internet. A plurality of shippers 52 are shown having a connection 53 to the Internet 60. The connections 53 may be telephone modems and lines, DSL modems and lines, cable modems and coaxial cables, or may be mcrowave links. Likewise, brokers 54 and freight forwarders 56 have connections 53 to Internet 60. A plurality of carriers 58, similarly, have connections 53 to Internet 60.

The invention 10 is, preferably, a plurality of web sites including a web site for shippers 20 and a web site for carriers 30. These web sites are computer programs hosted on hardware infrastructure 50, which is discussed subsequently. These computer programs, preferably, are written in visual basic. The programs exist as physical realities inasmuch as they receive physical signals from the business entities 52, 54, 56 and 58, and provide signals for physical output in the form of displays, printer output, and other output display signals. The signals exist in the hardware infrastructure 50 in the form of currents and voltages, magnetic domains, optical indicia, or other physical means. Web site 20 and web site 30 are connected to Internet 60 by high data rate connections 61, which, presently are 3x ethernet connections. Web site 20 and web site 30 share a common database 40 to which they are connected by high data rate connections 41, which presently are 3x ethernet connections.

The web site for shippers 20 has display screens and data entry fields to facilitate accomplishment of the tasks performed by shippers. Web site 20 includes Posting manager 22, which enables shippers to post loads. Posting manager 22, preferably, provides data entry fields for origin and destination of load, type of goods to be carried, weight of shipment, whether shipment is a full or partial load, and the type of carriage means required. Preferably, Posting manager 22 also provides for input of the time and date at which the load is to be delivered to the consignee, and one or more variable length data fields for shipper requirements. It is also preferred that means are provided to enable the shipper to select a preferred group of carriers, or tender a load to a preferred carrier. Preferably, the preferred group of carriers may be selected once and subsequently referenced by the shipper. It is also preferred that means be provided for automatically sending E-mail notifications regarding the shipment to a preferred carrier or group of carriers.

Web site 20 also includes Bid manager 24 which enables the shipper 52 to compare and evaluate bids from one or more of the carriers 58. Preferably, this web site enables shippers 52 to view notes they have previously provided as input concerning specific ones of the carriers 58. Award manager 25 provides means for awarding a contract to the carrier whose bid is selected.

Contract manager for shipper 26 provides for finalizing a contract with a carrier. Profile manager 27 enables a shipper to provide shipper profile information. Report manager for shipper 28 provides reports for shipper's management personnel.

The web site for carriers 30 includes a Search manager 32 which enables carriers 58 to search through the posted loads in database 40. Preferably, search manager 32 provides for searching based on specific search criteria in specific fields. The search criteria, preferably include nature of goods to be carried, type of carriage means required, and the city, state, and ZIP code or distance from city, state or ZIP code of origin, and/or destination of load.

The web site for carriers 30 also includes Bid manager 34, which enables carriers 58 to place information relating to bids in database 40. The Contract manager 35 for carrier enables carriers 58 to finalize contracts with shippers 52 for specific loads.

Profile manager 36 enables a carrier to provide carrier profile information for use by shippers 52 when evaluating bids. The Report manager for carrier 38 generates reports for carrier's management personnel.

Third parties in the transportation industry including brokers 54 and freight forwarders 56, likewise, have connections 53 to Internet 60, and thence through high data rate connections 61 to the web site for shippers 20 and the web site for carriers 30. The third parties 54 and 56 may post loads on behalf of shippers and may search for loads on behalf of carriers by means of web site for shippers 20 and web site for carriers 30. An early embodiment of the invention 10 is extant as the web sites BestShippers.com and BestCarriers.com. These are referenced by the web site BestTransport.com. BestShippers.com, BestCarriers.com and BestTransport.com are registered domain names and common law trademarks (service marks).

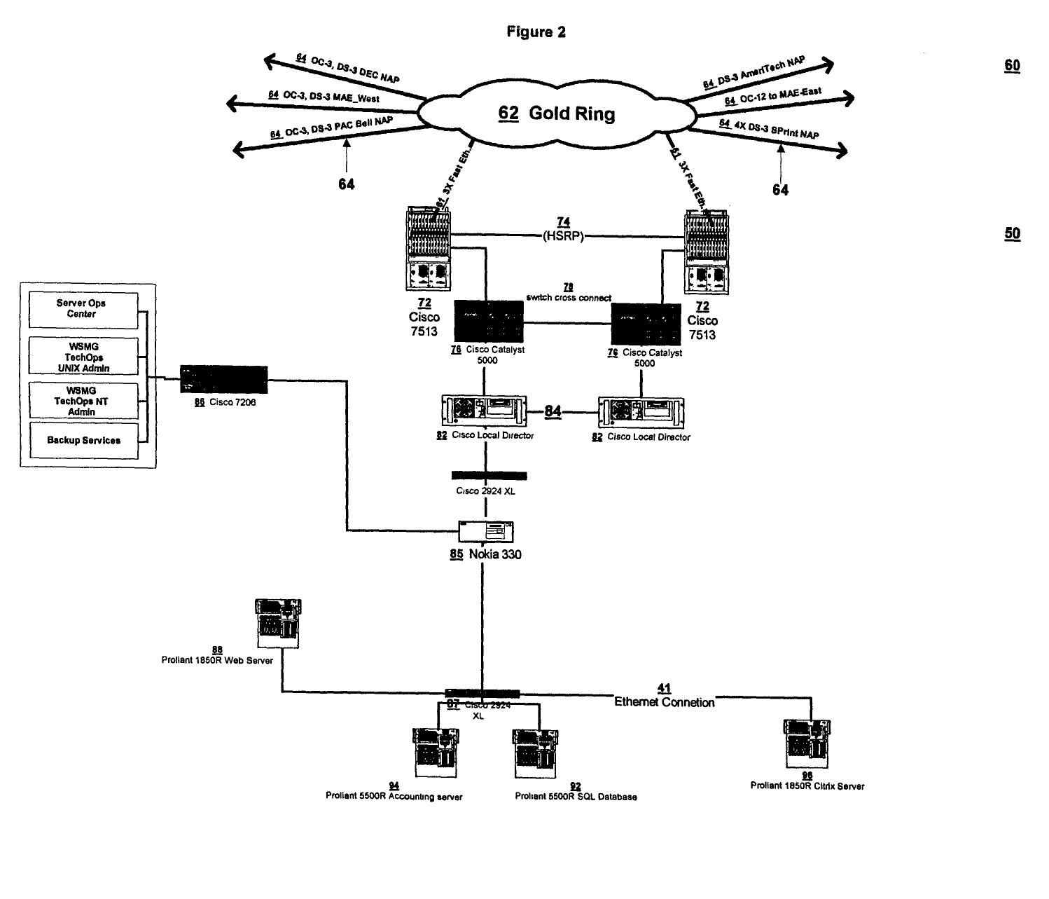

Attention is now directed to FIG. 2, which shows the hardware infrastructure 50 on which the invention 10 presently is hosted. In the following discussion, no indication is given as to whether commercial names for computer hardware and software have intellectual property protection, for example as trade names. This usage follows current practice in publications relating to computer hardware and software. Lack of such notification is not intended to imply that the various commercial names lack protection.

The hardware infrastructure 50 preferably has a high speed 3x ethernet connection 61 to Digex Gold Ring 62. The Digex Gold Ring is a portion of Internet 60 comprising a system of high data rate fiber optic transmission lines which link a number of metropolitan areas. Digex Gold Ring 62 is connected to other high capacity Internet transmission lines 64.

The ethernet connections 61 are attached to high end multiprotocol routers 72. These routers are connected to each other by connection 74 which employs the hot standby router protocol, HSRP. Routers 72 are connected to concentrators 76 which incorporate advanced encryption and authentication features. Concentrators 76 are cross connected by cross connection 78.

Concentrators 76 are attached to local directors 82 which are cross connected by connection 84. Nokia 330 is a firewall, designated 85, which is connected to routers 86 and to switch module 87.

Switch module 87 is connected to servers 88 and 96. On these servers the software of the invention is installed. With the software presently employed, additional servers may be added to accommodate increased traffic. The database server 92 provides storage for the database 40 with which the software of the invention interacts. Accounting functions are hosted on accounting server 94.

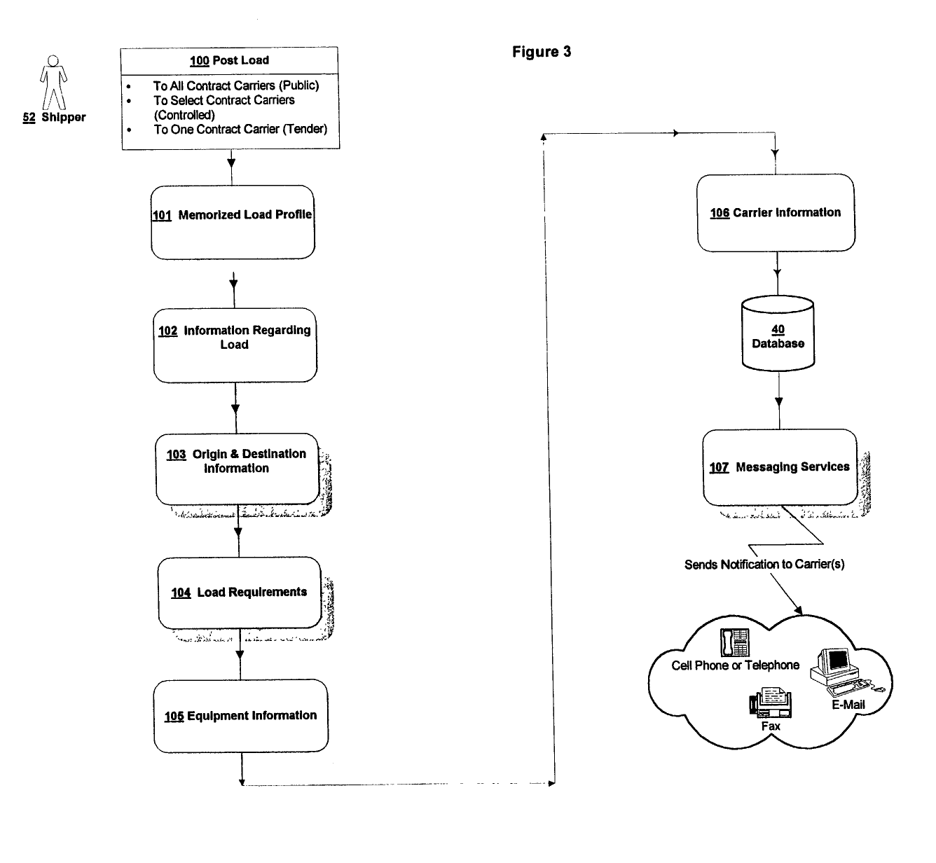

FIG. 3 illustrates the method 100 by which a shipper connects to the web site BestShippers.com and posts a load. In step 101, the shipper posts shipper profile information. Preferably, the shipper has the option of providing this information once and referencing it subsequently, or the shipper may provide the profile for a single load. In step 102, the shipper posts information regarding the load, including the nature of goods to be carried, and whether the load is a partial load. In step 103, the shipper posts information indicative of city, state, and ZIP code of the origin and destination of the load. In step 104, the shipper posts information, preferably to a data field having variable length, of the shipper's requirements for the load. Optionally, in step 105, the type of carriage means is stated, and in step 106, the shipper posts information of a preferred carrier or preferred group of carriers. The bidding may be public, controlled or tendered to a particular carrier. Optionally, in step 107, the shipper sends information to a preferred group of carriers, requesting the carriers to look at the posted load.

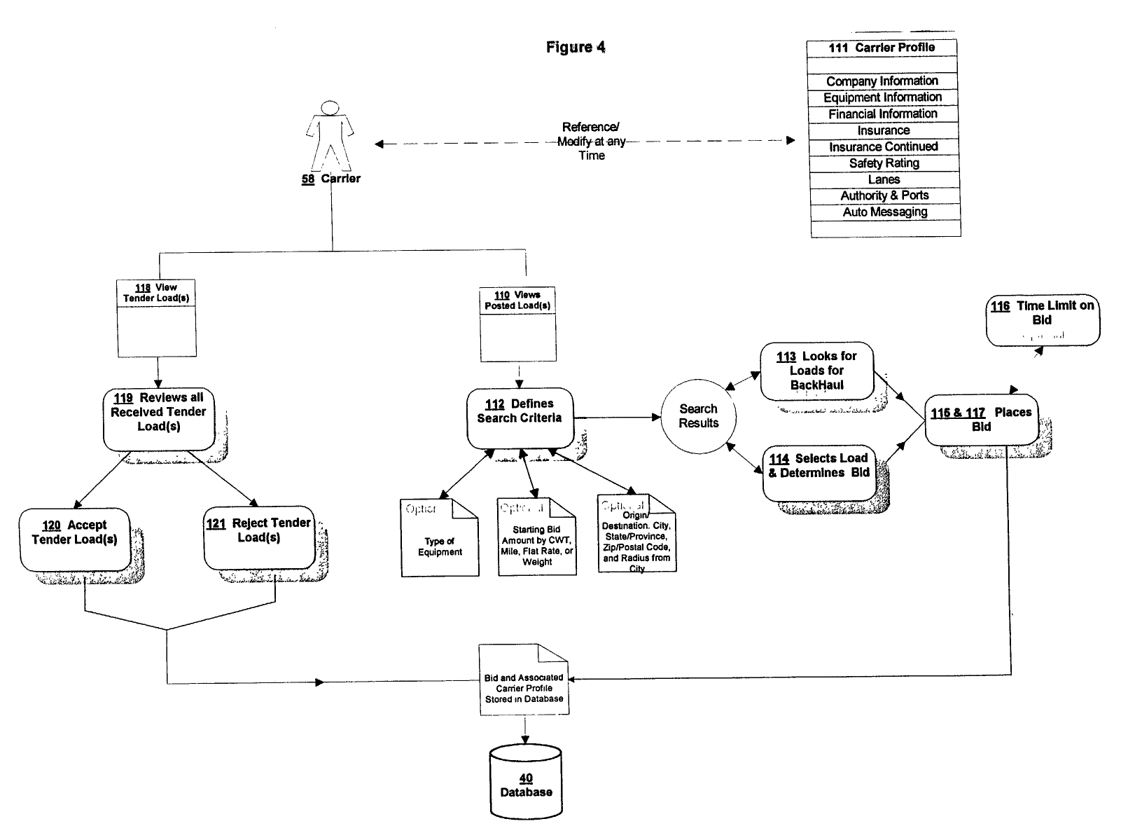

FIG. 4 illustrates the method by which a carrier connects to the web site BestCarriers.com and places a bid. In step 111, the carrier posts information indicative of the carrier profile. In step 110, the carrier views the posted loads. In step 112, the carrier defines search criteria, optionally including city, state, ZIP code, and distance from city, state or ZIP code of the origin and destination of the load, the type of goods to be carried, and the type of carriage means required. Optionally, in step 113, the carrier looks for a back haul by searching the posted loads. Preferably, web site 30 has a search routine in which the positions of origin and destination are reversed, while other search criteria are retained.

In step 114, the carrier selects a load determines a bid. In step 115, the bid is placed. Optionally, in step 116, the carrier places a time limit on the bid to encourage shipper to accept a low bid, and in step 117, the carrier, optionally places a bid for a back haul. In step 118, the carrier views the tendered loads and reviews them in step 119. The tendered loads are either accepted in step 120 or rejected in step 121.

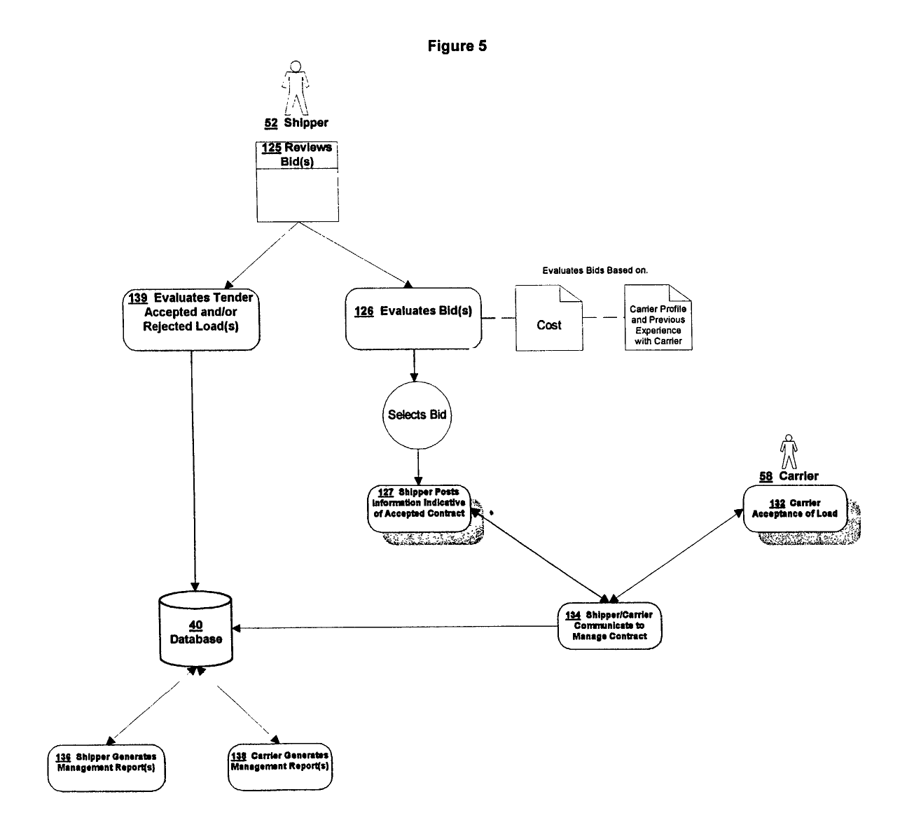

FIG. 5 illustrates subsequent method steps which shipper 52 and carrier 58 employ to finalize a contract. In step 125, the shipper reviews the bids. In step 139, the shipper evaluates accepted or rejected tendered loads. In step 126, the shipper evaluates bids on the basis of cost and the carrier profile. In step 127, the shipper posts information indicative of an accepted contract. In step 132, the carrier connects to BestCarriers.com and posts information indicative of carrier acceptance of load. In step 134, shipper and carrier communicate, as needed, to finalize a contract.

In step 136, the shipper generates a management report, and in step 138, the carrier generates a management report.

It is expected that the present invention will become a portion of a larger system including many other features. These features may include driver information including fuel availability and price as well as driver accommodations. The system may include various adaptations and modifications of the invention without departing from the scope of the claims that follow.

What is claimed is:

1. An integrated transportation apparatus for enabling a plurality of independent entities including a plurality of shippers and a plurality of carriers to conduct business transactions relating to shipment of goods, each of said plurality of entities having connection to a communication network, said apparatus comprising:
load posting means enabling a shipper to post information indicative of loads on a communication network;
load viewing means enabling a carrier to view said information indicative of said loads; and
bid placing means enabling said carrier to place bids on said communication network for carrier-selected ones of said loads.

2. An integrated transportation apparatus according to claim 1, wherein said load posting means further enables a plurality of shippers to place said information indicative of said loads on said communication network and said load viewing means further enables a plurality of carriers to view said information indicative of said loads.

3. An integrated transportation apparatus according to claim 2, further including evaluation means enabling said shippers to evaluate said bids and place information indicative of awarded contracts for shipper selected ones of said bids on said communication network.

4. An integrated transportation apparatus according to claim 3, further including confirmation means enabling said carriers to place information indicative of acceptance of carrier selected ones of said awarded contracts on said communication network.

5. An integrated transportation apparatus according to claim 2, wherein said bid placing means includes means, employable by said carriers, for placing time limits on said bids.

6. An integrated transportation apparatus according to claim 2, further including means for said carriers to find back hauls corresponding to said loads.

7. An integrated transportation apparatus according to claim 2, wherein said load posting means includes means for posting carrier requirements for said loads.

8. An integrated transportation apparatus according to claim 2, wherein said load viewing means includes means for searching said information indicative of said loads according to predetermined criteria.

9. An integrated transportation apparatus according to claim 8, wherein said predetermined criteria include one or more location criteria for at least one of source and destination of said loads.

10. An integrated transportation apparatus according to claim 9, wherein said one or more location criteria include at least one of city, state, and zip code.

11. An integrated transportation apparatus according to claim 9, wherein said one or more location criteria include radius information from at least one of city, state, and zip code.

12. An integrated transportation apparatus according to claim 8, wherein said predetermined criteria include the type of material or goods to be carried.

13. An integrated transportation apparatus according to claim 8, wherein said predetermined criteria include the type of carriage means required for said loads.

14. An integrated transportation apparatus according to claim 2, wherein said information indicative of loads includes information that a one of said loads is a partial load.

15. An integrated transportation apparatus according to claim 2, wherein said communication network is the Internet.

16. An integrated transportation apparatus according to claim 15, wherein said information indicative of loads is placed on said Internet in a markup language.

17. An integrated transportation apparatus according to claim 16, wherein said markup language is an extensible markup language.

18. An integrated transportation apparatus according to claim 15, wherein said load posting means and said bid placing means include business to business integration as options.

19. An integrated transportation apparatus according to claim 2, wherein said information indicative of one or more of said loads further includes information indicative of a preferred group of carriers, and said load viewing means restricts said viewing of said one or more of said loads to said preferred group of carriers.

20. An integrated transportation apparatus according to claim 2, wherein said information indicative of one or more of said loads further includes information indicative of a preferred carrier, and said load viewing means restricts said viewing of said one or more loads to said preferred carrier.

21. An integrated transportation apparatus according to claim 2, wherein said information indicative of one or more of said loads includes information indicative of required delivery times of said one or more of said loads.

22. An integrated transportation apparatus according to claim 2, wherein said plurality of independent entities includes third party entities including at least one of logistics companies and freight brokers and wherein said integrated transportation apparatus includes means for said third party entities to find at least one of loads for said carriers and carriers for said loads.

23. An integrated transportation apparatus according to claim 2, further including means for said shippers to send notification, via said communication network, to a preferred set of carriers to look at specific ones of said posted loads.

24. An integrated transportation method of enabling a plurality of independent entities including a plurality of shippers and a plurality of carriers to conduct business transactions relating to shipment of goods, each of said plurality of entities having connection to a communication network, said method comprising:
enabling said shippers to post information indicative of loads on said communication network;
enabling said carriers to view said information indicative of said loads; and
enabling said carriers to place bids for carrier selected ones of said loads.

25. An integrated transportation method according to claim 24, further including:
enabling said shippers to evaluate said bids and place information indicative of awarded contracts for shipper selected ones of said bids on said communication network.

26. An integrated transportation method according to claim 25, further including:
enabling said carriers to place information indicative of acceptance of carrier selected ones of said awarded contracts on said communication network.

27. An integrated transportation apparatus for enabling a plurality of independent entities including a plurality of shippers and a plurality of carriers to conduct business transactions relating to shipment of goods, each of said plurality of entities having connection to a communication network, comprising:
load posting means enabling said shippers to post information indicative of loads on said communication network, said information indicative of loads including type of load, type of carriage means required, required delivery time and date, city, state, and zip code of point of origin of load, city, state, and zip code of destination of load and shipper requirements for said loads;
load viewing means enabling said carriers to view said information indicative of said loads, said load viewing means including search means enabling said carriers to search for type of load, type of carriage means required, required delivery time and date, city, state, and zip code of point of origin of load, city state, and zip code of destination of loads and back hauls corresponding to said loads;
bid placing means enabling said carriers to place bids for carrier selected ones of said loads on said communication network, said bid placing means including means for placing time limits on said bids;
evaluation means enabling said shippers to evaluate said bids and place information indicative of awarded contracts for shipper selected ones of said bids on said communication network; and
confirmation means enabling said carriers to place information indicative of acceptance of carrier selected ones of said awarded contracts on said communication network.
